(19) United States
(12) Patent Application Publication
(10) Pub. No.: US 2008/0000720 A1
(43) Pub. Date: Jan. 3, 2008

(54) LADDER ANCHORING SYSTEM

(76) Inventors: John Porch, Mullica Hill, NJ (US); William Bosher, Millville, NJ (US)

Correspondence Address: WOOD AND EISENBERG, PLLC, 6911 RICHMOND HIGHWAY, SUITE 403, Alexandria, VA, 22306, US

(21) Appl. No.: 11/427,032

(22) Filed: Jun. 28, 2006

(51) Int. Cl. E06C 7/42

(52) U.S. Cl. 182/107

(57) ABSTRACT

A ladder anchoring system for ladders with hollow bore ladder rungs, which includes: first and second vertical shafts each having a hollow bore disposed between opposite open ends; first and second elongated ladder securing members dimensioned to respectively slideably fit through the hollow bores of the first and second vertical shafts; and first and second horizontal members. The first and second horizontal members are attached in parallel and between the first and second vertical shafts. At least one of the first and second vertical shafts is detachable from the first and second horizontal members. An attachment means is provided for reversibly securing the first and second horizontal members to at least one of the first and second vertical shafts.

### CROSS-REFERENCE TO RELATED APPLICATIONS

Not applicable.

### STATEMENT REGARDING FEDERALLY SPONSORED RESEARCH OR DEVELOPMENT

Not Applicable.

### FIELD OF THE INVENTION

This invention relates to ladder anchoring systems.

### BACKGROUND OF THE INVENTION

Accident and/or Emergency Departments in hospitals throughout the country are familiar with accidents involving falls from ladders. The cost to the individuals that suffer accidents while using ladders can be enormous both in terms of personal medical costs and impact on earnings through lost working time. Apart from the personal cost, the financial cost to the community can be large particularly if a ladder accident causes the loss of life of a parent.

Assistants can be used to help prevent accidents. For example, an assistant can hold onto the bottom of the ladder to stop the base of a ladder moving. Thus, a person can use the ladder knowing that someone is holding the bottom of the ladder. Accidents due to ladders slipping or moving relative to the ground while in use are less likely when someone is holding the ladder to stop it from moving.

In typical use, a person places the work ladder against the side of the building and proceeds to climb to various points up the ladder. The person working on the ladder typically carries one or more implements and material for repairing and maintaining the exterior of the building. For example, a person working atop a ladder might carry paintbrushes, paint cans, cement, concrete repainting tools, paint scraping tools, etc. Such a person has to remain balanced and attached to the ladder while using such items as scraping tools and repair media such as wet cement or paint.

There is plenty of scope for the person working on the ladder to inadvertently drop tools onto the head of the person holding the bottom of the ladder. In addition, while health and safety issues are of paramount importance, the requirement for an assistant to secure the bottom end of the ladder leads to a loss in work productivity. There is a need for new ways of securing the bottom of ladders that do not require human helpers to perform the same task.

U.S. Pat. No. 4,836,331, issued Jun. 6, 1989 to Paul T. Foradori, describes a device attachable to the stiles of a ladder as a means to stabilize the ladder against slipping. The '331 device comprises: a ground-penetrating spike, an elongated bent metal strip, a compression harbor, and a handle.

U.S. Pat. No. 6,935,463, issued Aug. 30, 2005 to Brewster, describes a ladder safety support for use with an existing ladder. The support includes an attachment assembly for removable connection to the lower end of the ladder and one of two interchangeable foot assemblies for supporting the ladder on a surface. The first foot assembly provides a surface-penetrating stake having a lower tapered section and presenting a pointed tip and a threaded portion for removably attaching the stake to the assembly. The second foot assembly is similarly removable and provides a surface-engaging pad.

U.S. Patent Publication No. 2001/0015303, published Aug. 23, 2001 to Laug, describes a slip prevention device for ladders with hollow ladder-rung profiles. The Laug '303 device includes: male/female length-adjustable fastening spindles guided through a hollow rung of a ladder, a pair of support guides articulated on and firmly braced on the ladder by the fastening spindles, and a pull/push rod disposed to lock each the support guide on the ladder at various angles and pivotable from a lean-to side/rear side to a front side/climbing side of the ladder. Whatever the merits of the Laug '303 device, it is a complicated design, and is not specifically designed to prevent slippage of the ladder when placed on, for example, an outside grass area where a more robust system for anchoring the ladder to the ground is required.

### SUMMARY OF THE INVENTION

A ladder anchoring system for ladders with hollow bore ladder rungs, which includes: first and second vertical shafts each having a hollow bore disposed between opposite open ends; first and second elongated ladder securing members dimensioned to respectively slideably fit through the hollow bores of the first and second vertical shafts; and first and second horizontal members. The first and second horizontal members are attached in parallel and between the first and second vertical shafts. At least one of the first and second vertical shafts is detachable from the first and second horizontal members. An attachment means is provided for reversibly securing the first and second horizontal members to at least one of the first and second vertical shafts.

### BRIEF DESCRIPTION OF THE DRAWINGS

FIG. 1A is an environmental perspective view of a ladder anchoring system, according to the present invention.

FIG. 1B is a close up view of the ladder anchoring system shown in FIG. 1A.

FIG. 2 is a perspective view of a first embodiment of the invention in relation to a prior art ladder with hollow bore ladder rungs.

FIG. 3 is a close up perspective view of the first embodiment of the invention.

FIG. 4 is a perspective view of a second embodiment of the ladder anchoring system.

FIG. 5 is a perspective view of the second embodiment of the invention in relation to a prior art ladder with hollow bore ladder rungs.

Similar reference characters denote corresponding features consistently throughout the attached drawings.

### DETAILED DESCRIPTION OF THE PREFERRED EMBODIMENTS

This invention is directed to a ladder anchoring system. More specifically, the invention is a ladder anchoring system that anchors the bottom of a ladder to the ground to prevent slippage. The ladder anchoring system is generally denoted by the numeric label “100”.

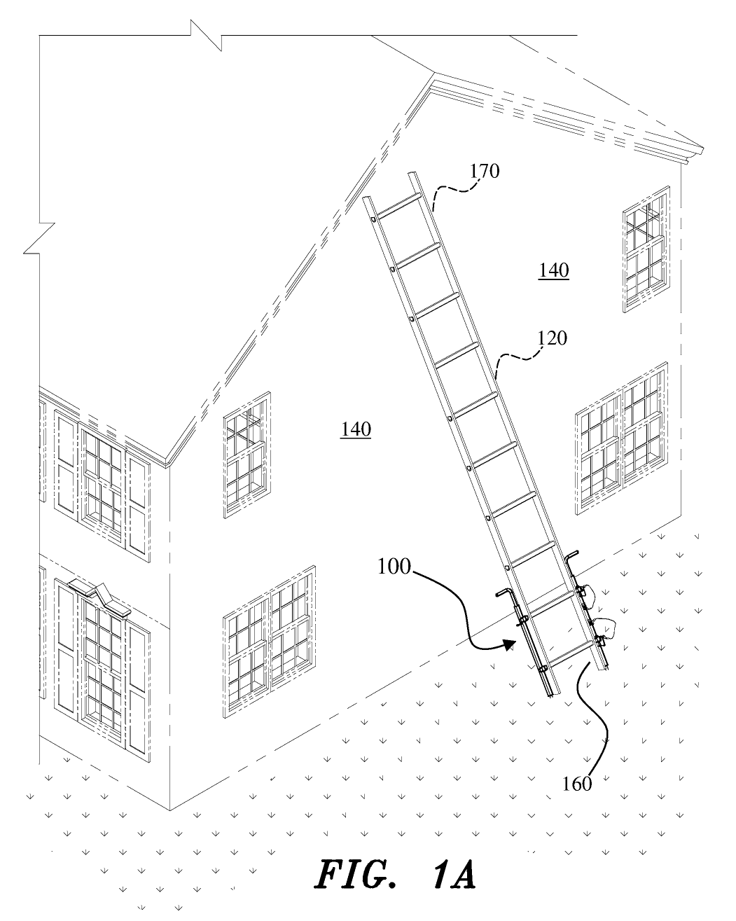

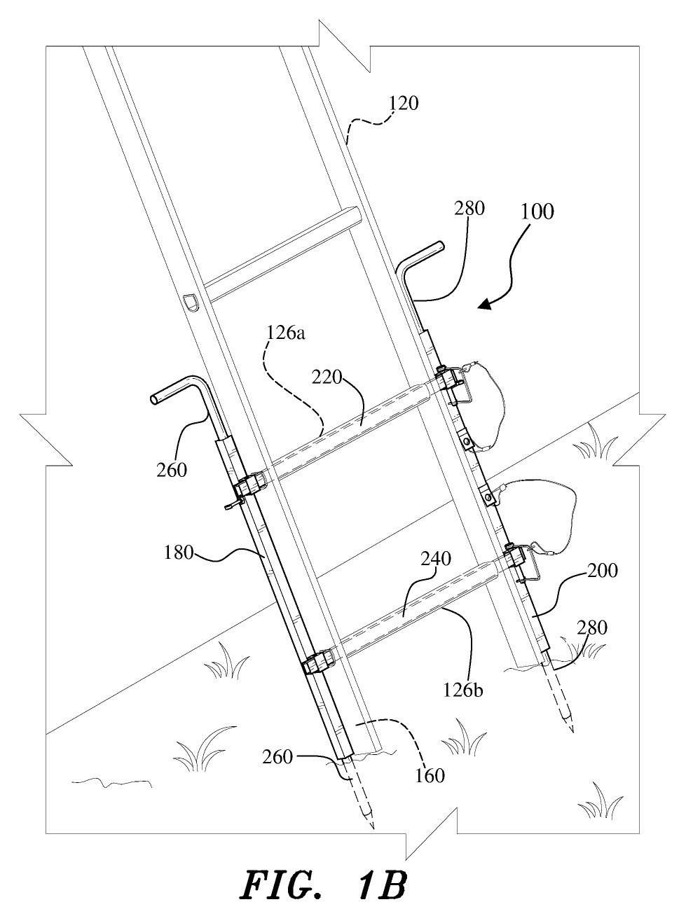

Referring to FIGS. 1A and 1B, FIG. 1A is an environmental perspective view of the ladder anchoring system 100. The ladder anchoring system 100 is shown fitted to a ladder 120 placed against the side of a house 140. More specifically, the ladder anchoring system 100 is shown fitted to the bottom end 160 of ladder 120, wherein the top part 170 of ladder 120 is resting against the side of the house 140. FIG. 1B shows a close up view of the ladder anchoring system 100 shown in FIG. 1A.

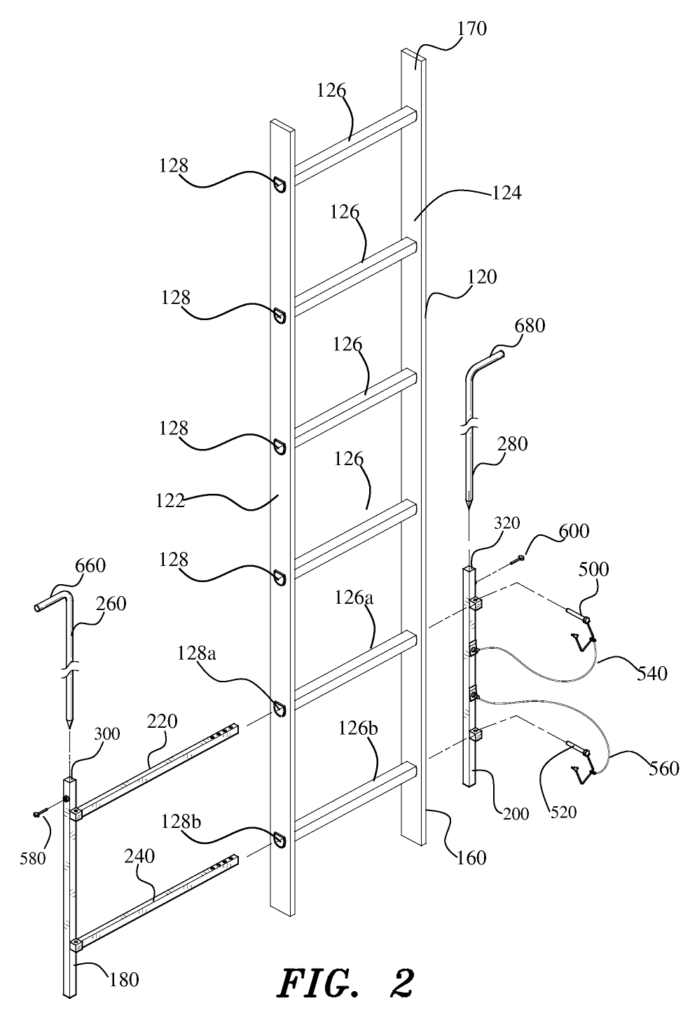

FIG. 2 is a perspective view of a first embodiment of the invention in relation to a prior art ladder with hollow bore ladder rungs. It should be understood that the ladder shown is a non-limiting example of a prior art ladder. The ladder 120 comprises elongated parallel ladder sides 122 and 124, with ladder rungs 126 disposed therebetween. At least some of the ladder rungs 126 have hollow bores 128. The ladder rungs 126 are typically about one foot apart. More specifically, ladder 120 comprises at least two consecutive hollow bore ladder rungs (represented by alpha-numeric labels 126a and 126b).

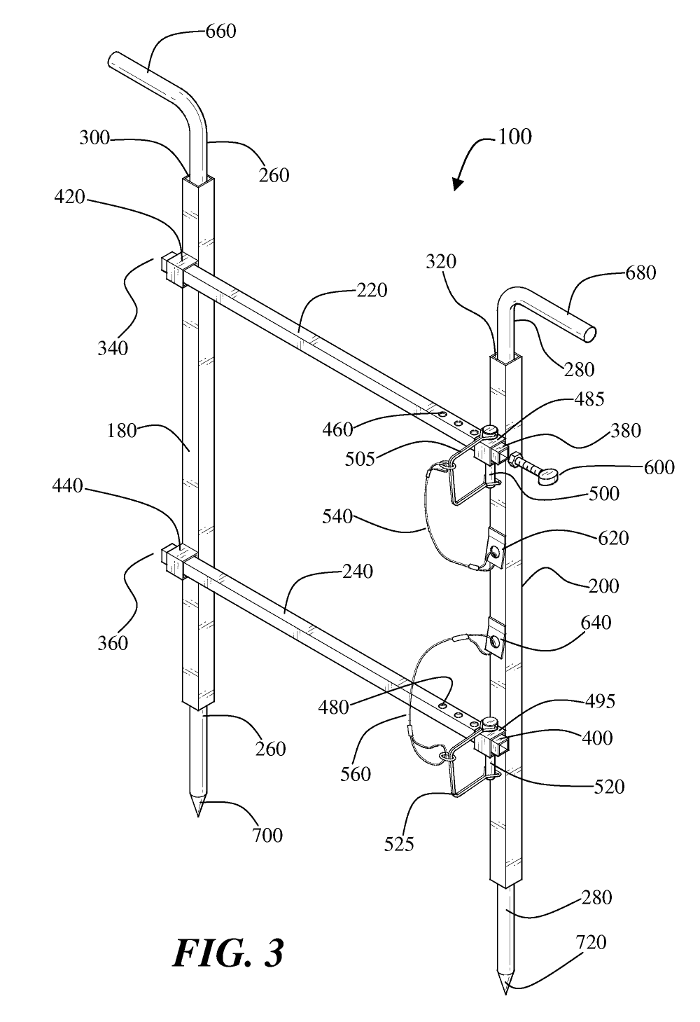

Referring to FIGS. 2 and 3 that illustrate the first embodiment of the invention, the ladder anchoring system 100 comprises: first and second vertical shafts 180 and 200, respectively; first and second horizontal members 220 and 240, respectively; and first and second elongated ladder securing members 260 and 280, respectively. The first and second vertical shafts 180 and 200 define hollow bores 300 and 320, respectively. The first and second horizontal members 220 and 240 respectively define first ends 340 and 360, and second ends 380 and 400 as shown, for example, in FIG. 3. In this embodiment, the first ends 340 and 360 are permanently attached to the first vertical shaft 180.

Still referring to FIGS. 2 and 3, upper and lower brackets 420 and 440 respectively affix first ends 340 and 360 permanently to the first vertical shaft 180. The first and second horizontal members 220 and 240 are attached at a perpendicular angle and in parallel to the same side of the first vertical shaft 180. Inserting the first and second horizontal members 180 and 200 into two consecutive hollow bore ladder rungs are facilitated by having the first ends 340 and 360 permanently attached to first vertical shaft 180. More specifically, the first vertical shaft 180 is maneuvered to insert horizontal member ends 380 and 400 into adjacent hollow rungs (represented by alpha-numeric labels 126a and 126b in FIG. 2) and the horizontal members 220 and 240 slid through adjacent hollow rungs to expose ends 380 and 400 for reversible attachment to the second vertical shaft 200 using securing pins 500 and 520.

The first and second horizontal members 220 and 240 are typically multiples of one foot apart. For example, first and second horizontal members 220 and 240 can be about one foot apart for insertion through adjacent hollow bore ladder rungs (exemplified by rungs 126a and 126b in FIG. 2). For example, first and second horizontal members 220 and 240 can be about two feet apart and sized to be slidably insertable through alternate hollow bore ladder rungs, i.e., hollow bore ladder runs about two feet apart. Thus, the distance between the first and second horizontal members 220 and 240 can be chosen by the manufacturer to suit specific ladder models. Put yet another way, the distance between the first and second horizontal members 220 and 240 can be selected by the examiner to be any suitable distance value such as, but not limited to, between about 1 foot and about 2 feet; between about one foot and about 5 feet. For example, if the horizontal members 220 and 240 were about five feet apart, the user could insert the horizontal members 220 and 240 through hollow bore ladder rungs about 5 feet apart.

Still referring to the embodiment shown in FIGS. 2 and 3, horizontal member ends 380 and 400 respectively include through-apertures 460 and 480. Horizontal member ends 380 and 400 fit into brackets 485 and 495 located on second vertical shaft 200. Securing pins 500 and 520, which are sized to fit in through-apertures 460 and 480, are respectively used to reversibly lock horizontal members 220 and 240 to second vertical shaft 200, and more specifically to brackets 485 and 495 attached to second vertical shaft 200. Securing screws 580 and 600 (shown in FIG. 2) respectively secure first and second elongated securing members 260 and 280 inside first and second vertical members 180 and 200. The securing screws 580 and 600 can be replaced with any suitable securing mechanism such as a round knob lock down for easy tightening and loosening (re: securing and releasing the first and second elongated securing members 260 and 280 inside first and second vertical members 180 and 200).

Still referring to the embodiment shown in FIGS. 2 and 3, the tops of first and second elongated securing members 260 and 280 are optionally fashioned into handles 660 and 680, respectively. The bottoms of first and second elongated securing members 260 and 280 are optionally fashioned into sharp tips 700 and 720, respectively.

Optional attachment wires 540 and 560 are attached to the second vertical shaft 200. One end of attachment wires 540 and 560 are attached to the second vertical shaft 200 by means of wire securing members 620 and 640. The optional attachment wires 540 and 560 respectively keep pins 500 and 520 connected to the second vertical shaft 200 with the aid of two-ended pin-attachment loops 505 and 525. One end of pin-attachment loop 505 is permanently wrapped around the head of securing pin 500, and one end of pin-attachment loop 525 is permanently wrapped around the head of securing pin 520. The optional attachment wires 540 and 560 respectively ensure that pins 500 and 520 are always at hand and not lost.

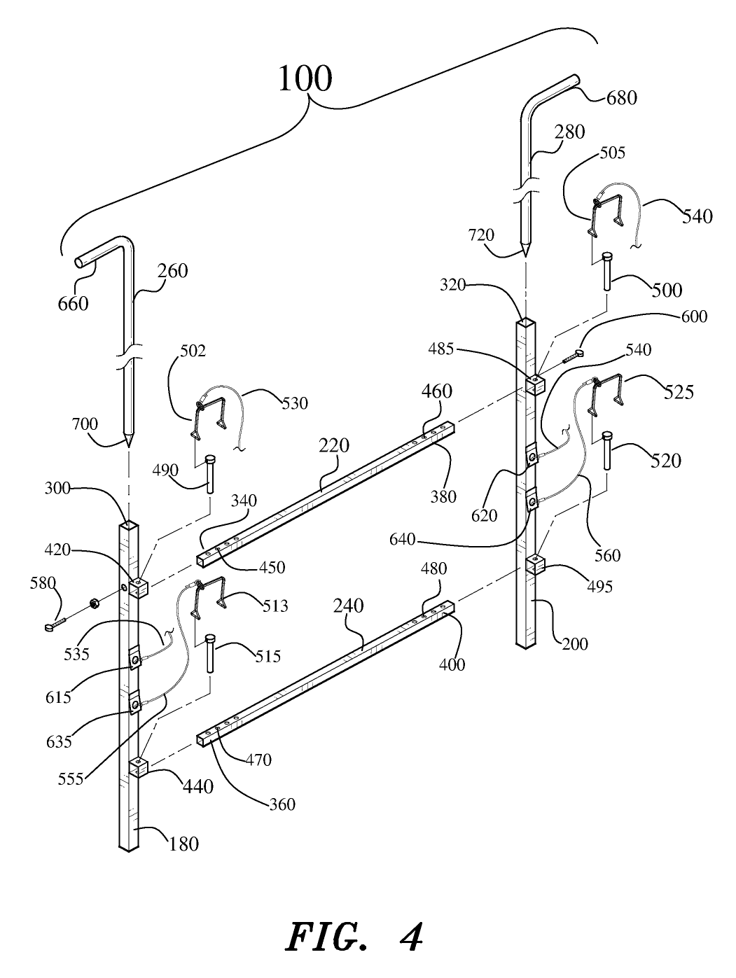

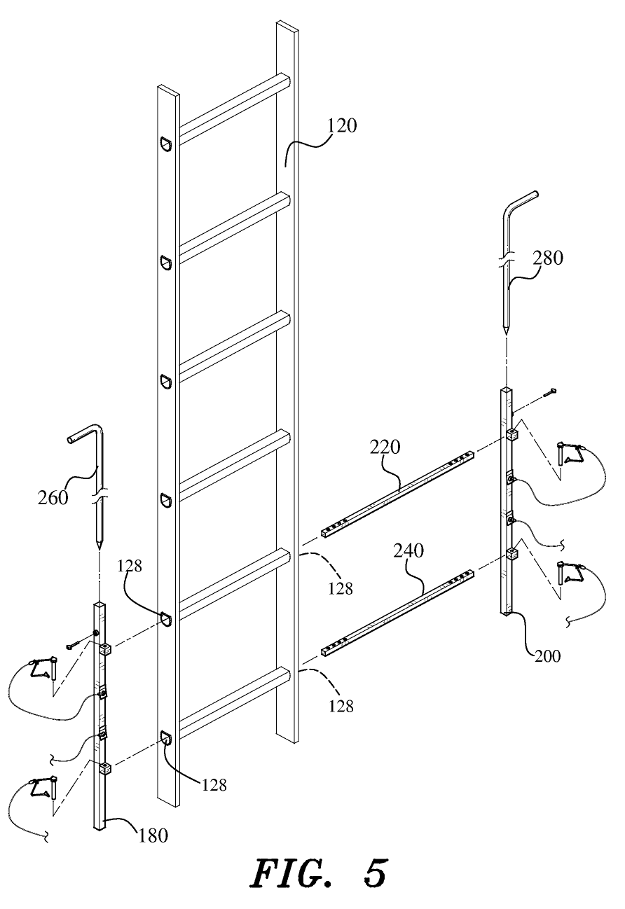

Referring to FIGS. 4 and 5, which show another embodiment in which both ends of the first and second horizontal members 220 and 240 are reversibly attachable (and hence reversibly detachable) to first and second vertical members 180 and 200. In this embodiment, any suitable means are used for reversibly attaching the ends of both horizontal members to first and second vertical members 180 and 200 such as, but not limited to, securing pins 490, 500, 515 and 520 (see FIG. 4). More specifically, in the second embodiment of the invention, ends 340 and 360 are not permanently attached to the first vertical shaft 180.

Still referring to FIGS. 4 and 5, the opposite ends of both horizontal members 220 and 240 include through-apertures. More specifically, ends 340, 380, 360, 400 define through-apertures 450, 460, 470, and 480. In this embodiment the horizontal members 220 and 240 can be inserted into and through hollow bore ladder rungs and then reversibly attached to vertical members 180 and 200 using securing pins 490, 500, 515, and 520 (see FIG. 4). The pins 490 and 515 work in cooperation with optional two-ended pin-attachment loops 502 and 513. Optional bolt attachment wires 530 and 555 can be used to keep pins 490 and 515 attached to the first vertical member 180 facilitated by wire securing members 615 and 635 as shown in FIG. 4.

The ladder anchoring system 100 has several positive features including: (1) can be installed or removed in less than one minute; (2) can be moved from one ladder to another by a human worker without using tools; (3) does not require any holes to be drilled into the ladder for installation; (4) no requirement for additional nuts or bolts for installation; the first and second elongated ladder securing members 260 and 280 can be supplied in different styles (e.g., with longer or shorter spikes) to suit different ground conditions.

It is to be understood that the present invention is not limited to the embodiments described above or as shown in the attached figures.

I claim:

1. A ladder anchoring system for ladders with hollow bore ladder rungs, comprising:
first and second vertical shafts each having a hollow bore disposed between opposite open ends;
first and second elongated ladder securing members, wherein said first and second securing members are dimensioned to respectively slideably fit inside and through said hollow bores of said first and second vertical shafts;
first and second horizontal members each having first and second opposite ends, wherein said first and second horizontal members are attached at a perpendicular angle and in parallel between said first and second vertical shafts, wherein at least one of said first and second vertical shafts is detachable from said first and second horizontal members, and wherein said first and second horizontal members are about one foot apart and sized to be separately insertable through adjacent hollow bore ladder rungs in a ladder having hollow bore ladder rungs; and
an attachment means for reversibly securing said first and second horizontal members to at least one of said first and second vertical shafts.

2. The ladder anchoring system according to claim 1, wherein said first and second elongated ladder securing members each have top and bottom sections, wherein each of said top sections are shaped to form a handle.

3. The ladder anchoring system according to claim 1, wherein said first and second elongated ladder securing members each have top and bottom sections, wherein each of said top sections are shaped to form a handle, and further wherein each of said bottom sections are shaped to form a spike.

4. The ladder anchoring system according to claim 1, further comprising first and second means to separately reversibly secure said first and second elongated ladder securing members inside said first and second vertical shafts.

5. A ladder anchoring system for ladders with hollow bore ladder rungs, comprising:
first and second vertical shafts each having a hollow bore;
first and second horizontal members each having first and second ends, the first ends of said first and second horizontal members are respectively affixed at first and second predetermined points on said first vertical shaft, wherein the first and second horizontal members extend in parallel at a perpendicular angle and in the same direction from said first vertical shaft;
first and second elongated ladder securing members, wherein said first and second securing members are dimensioned to respectively fit inside said hollow bores of said first and second vertical shafts;
a first attachment means for attaching said second end of said first horizontal member to said second vertical shaft; and
a second attachment means for attaching said second end of said second horizontal member to said second vertical shaft;
whereby having the first ends of both first and second horizontal members permanently attached to said first vertical shaft facilitates inserting the first and second horizontal members into two consecutive hollow bore ladder rungs.

6. A ladder anchoring system and ladder combination, said combination comprising:
a ladder having two ends, wherein said ladder comprises first and second elongated ladder side members and at least two hollow bore ladder rungs disposed between said first and second elongated side members, wherein said at least two hollow bore ladder rungs includes first and second hollow bore ladder rungs;
first and second vertical shafts each having a hollow bore, wherein said first and second vertical shafts are respectively located lengthwise alongside said first and second elongated ladder side members at one end of said ladder;
first and second horizontal members each having opposite first and second ends, wherein said first and second horizontal members are respectively located inside said first and second hollow bore ladder rungs, wherein said first ends of said first and second horizontal members are connected to said first vertical shaft, wherein said second ends of said first and second horizontal members are connected to said second vertical shaft; and
first and second elongated ladder securing members, wherein said first and second securing members are respectively located inside said hollow bores of said first and second vertical shafts.

7. The ladder anchoring system and ladder combination according to claim 6, wherein first and second hollow bore ladder rungs are located one above the other at one end of said ladder.

8. The ladder anchoring system and ladder combination according to claim 6, said first and second hollow bore ladder rungs are separated by at least one other ladder rung.

9. The ladder anchoring system and ladder combination according to claim 6, wherein first and second elongated ladder securing members each have top and bottom ends, wherein said top ends of said first and second elongated ladder securing members are both fashioned into a handle shape, and said bottom ends of said first and second elongated ladder securing members are both fashioned into a spike shape.

10. The ladder anchoring system and ladder combination according to claim 9, wherein said ladder is secured to a piece of spike penetrable ground by forcing said spike ends of said first and second elongated ladder securing members into the ground.
